(19) United States
(12) Patent Application Publication
(10) Pub. No.: US 2004/0151966 A1
(43) Pub. Date: Aug. 5, 2004

(54) Various filter elements for hydrogen fuel cell

(76) Inventors: Andrew Christian Dahlgren, Chanhassen, MN (US); Katsushi Isogawa, Eagan, MN (US); Robert Oscar Nelson, Hastings, MN (US); Eivind Stenersen, River Falls, WI (US); Daniel Tuma, St. Paul, MN (US)

Correspondence Address: MERCHANT & GOULD PC, P.O. BOX 2903, MINNEAPOLIS, MN, 55402-0903, US

(21) Appl. No.: 10/727,027

(22) Filed: Dec. 2, 2003

Related U.S. Application Data
(60) Provisional application No. 60/430,483, filed on Dec. 2, 2002.

(51) Int. Cl. H01M 8/04

(52) U.S. Cl. 429/34

(57) ABSTRACT

Filter assemblies that manage the movement of gases and water to and from the anode and cathode of fuel cells. The assemblies are particularly suited for methanol and other liquid fuel sources for portable hydrogen fuel cells. These fuel cells and filter elements can be used with equipment such as telephones, personal computing devices, lap top computers, and pagers. The invention provides a filter assembly that forms a selectively permeable barrier between the exterior of the fuel cell and the cathode. The filter assembly manages the exposure of the cathode to particulate and gaseous materials. The filter assembly can also manage the movement of water. The invention also provides a filter assembly that forms a selectively permeable barrier between liquid (e.g., methanol and water) and the exterior of the fuel cell. The filter assembly manages the movement of liquids and gaseous materials away from the anode.

This application claims priority under 35 U.S.C. § 119(e) to U.S. provisional application serial No. 60/430,483, filed Dec. 2, 2002 and entitled “Various Filter Elements for Hydrogen Fuel Cell”. The entire disclosure of 60/430,483 is incorporated herein by reference.

The present invention is directed to hydrogen fuel cells and various contaminant filters for use therewith. More specifically, this invention is directed to a filter configuration on the oxidant side of a hydrogen fuel cell to protect the fuel cell from contaminants and to manage water. This invention is also directed to a filter configuration on the fuel side of a hydrogen fuel cell that uses methanol or other liquid as its fuel.

### BACKGROUND OF THE INVENTION

The use of fuel cells as a power source is a quickly growing industry. Fuel cells are touted as being environmentally friendly, as they do not rely on fossil fuels and provide no harmful or detrimental emissions. A fuel cell is similar to a battery, with an anode and a cathode whereby power is generated through a catalytic reaction. One common type of fuel cell is a hydrogen fuel cell, which uses hydrogen as the fuel. Hydrogen or a hydrogen source is available to the anode, where hydrogen electrons are freed, leaving positively charged ions. The freed electrons travel through an external circuit to the cathode and, in the process, provide an electrical current that can be used as a power source for external electrical circuits. The positively charged ions diffuse through the fuel cell electrolyte and to the cathode where the ions combine with the electrons and oxygen to form water and carbon dioxide, by-products of the process. To speed the cathodic reaction, a catalyst is often used.

Methanol is a common source of the hydrogen fuel. Fuel cells using methanol commonly referred to as direct methanol fuel cells (DMFC). Methanol fuel cells have a source of liquid methanol in fluid communication with the anode. In some designs, a volume of methanol is directly adjacent to or in contact with the anode, rather than positioned at a remote location and fluidly connected to the fuel cell. Having the methanol adjacent is particularly useful for portable methanol fuel cells, such as those used to power portable equipment such as lap top computers, telephones, pagers, and personal computing devices.

What is desired is an arrangement to improve the feasibility and reliability of portable fuel cells, such as direct methanol fuel cells.

### SUMMARY OF THE INVENTION

The present invention provides various filter assemblies that, either together or alone or in any combination, are particularly suited for small or portable fuel cells, such as hydrogen fuel cells and direct methanol fuel cells. These fuel cells and filter elements can be used with portable equipment such as telephones, personal computing devices, lap top computers, and pagers.

The present invention further provides a filter assembly positioned on the oxidant or cathode side of a fuel cell, the filter forming a selectively permeable barrier between the environment, typically ambient air, and the fuel cell cathode. The filter assembly manages the exposure of the cathode to particulate and gaseous materials. The filter assembly also manages the movement of cathode gases and water toward and away from the cathode. Specifically, the filter assembly allows the passage of both gases and water vapor therethrough, and regulates their flow rates.

The present invention further provides a filter assembly positioned on the anode side of a methanol fuel cell, the filter forming a selectively permeable barrier between the liquid fuel (e.g., methanol) and air, typically, ambient air. The filter assembly manages the movement of liquids and gaseous materials away from the anode. Specifically, the filter assembly allows passage of gases therethrough and inhibits the passage of liquid therethrough.

In a preferred embodiment, the first filter assembly allows passage of desirable gaseous molecules such as air or other oxygen source both toward the cathode, but inhibits passage of particulate and gaseous chemical contaminants that might affect fuel cell performance, contaminants such as hydrocarbons (VOCs), acid gases (e.g., SO₂, H₂S, Cl₂, NOx) and base gases (e.g., ammonia). The first filter assembly also manages the cathode humidity and passage of gaseous water from the cathode. The first filter assembly includes a membrane and preferably an adsorbent material; the membrane for particulate filtration and the adsorbent material for chemical filtration. The first filter assembly also includes a water or moisture buffer, to stabilize the relative humidity at the cathode.

In another preferred embodiment, the second filter assembly allows passage of gaseous molecules, such as air (oxygen, nitrogen, argon, etc.) and by-products such as carbon dioxide, therethrough between the atmosphere and the anode, but resists passage of liquid such as methanol and water. The second filter assembly includes a hydrophobic and/or oleophobic material to provide the selectively permeable barrier. The selectively permeable barrier preferably also provides particulate filtration, by not allowing passage of particles therethrough. The second filter assembly may additionally include an adsorbent material, to adsorb materials such as formic acid and formaldehyde, etc., rather than have them expelled into the atmosphere.

Each of the first filter assembly and the second filter assembly may be a single element or may be composed of multiple elements.

In one particular embodiment, a fuel cell assembly is provided, the assembly having a portable fuel cell having a cathode in fluid connection with an oxidant intake port and an anode, and a filter assembly positioned in fluid connection with the oxidant intake port and the cathode. The filter assembly includes a particulate removal feature, a chemical adsorbent feature, and a water buffer feature. The filter assembly is constructed and configured in the fuel cell so that oxidant, entering via the intake port, passes through the particulate removal feature and contacts the chemical adsorbent feature, and so that water vapor, from the cathode, is managed by the water buffer feature to achieve a desired humidity level at the cathode.

In another particular embodiment, a fuel cell assembly is provided, the assembly comprising a portable direct methanol fuel cell and a filter assembly. The fuel cell has a cathode, an anode, and a liquid methanol source in fluid contact with the anode, the methanol retained in a compartment having a vent, the vent providing fluid contact between an interior of the compartment and an exterior of the compartment. The filter assembly is positioned within the vent, and is configured for fluid connection between the interior of the compartment and the exterior of the compartment. The filter assembly comprises a hydrophobic and/oleophobic feature, such as a membrane of polytetrafluoroethylene (PTFE), polyvinylidene fluoride (PVDF), or polypropylene (PP).

Various other embodiments are disclosed and claimed.

### BRIEF DESCRIPTION OF THE DRAWINGS

FIG. 1 is a schematic diagram of a system comprising a methanol fuel cell including liquid methanol fuel, a first filter assembly according to the present invention on the fuel cell cathode side, and a second filter assembly according to the present invention on the fuel cell anode side;

FIG. 2 is schematic view of a portable telephone, which is one specific example suitable for the system of FIG. 1;

FIG. 3 is a schematic view of a personal computing device, which is another specific example suitable for the system of FIG. 1;

FIG. 4 is a schematic, cross sectional view of a portion of the system of FIG. 1, showing the anode, liquid methanol fuel and the second filter assembly;

FIG. 5 is a top view of a first embodiment of the first filter assembly of FIG. 1;

FIG. 6A is a cross-sectional view of the first filter assembly taken along line 6-6 of FIG. 5;

FIG. 6B is a cross-sectional view of an alternate first filter assembly, similar to the view of FIG. 6A;

FIG. 7 is a perspective view of a second embodiment of the first filter assembly of FIG. 1;

FIG. 8 is a cross-sectional view of the first filter assembly taken along line 8-8 of FIG. 7; and

FIG. 9 is a cross-sectional view of a third embodiment of the first filter assembly of FIG. 1.

### DETAILED DESCRIPTION

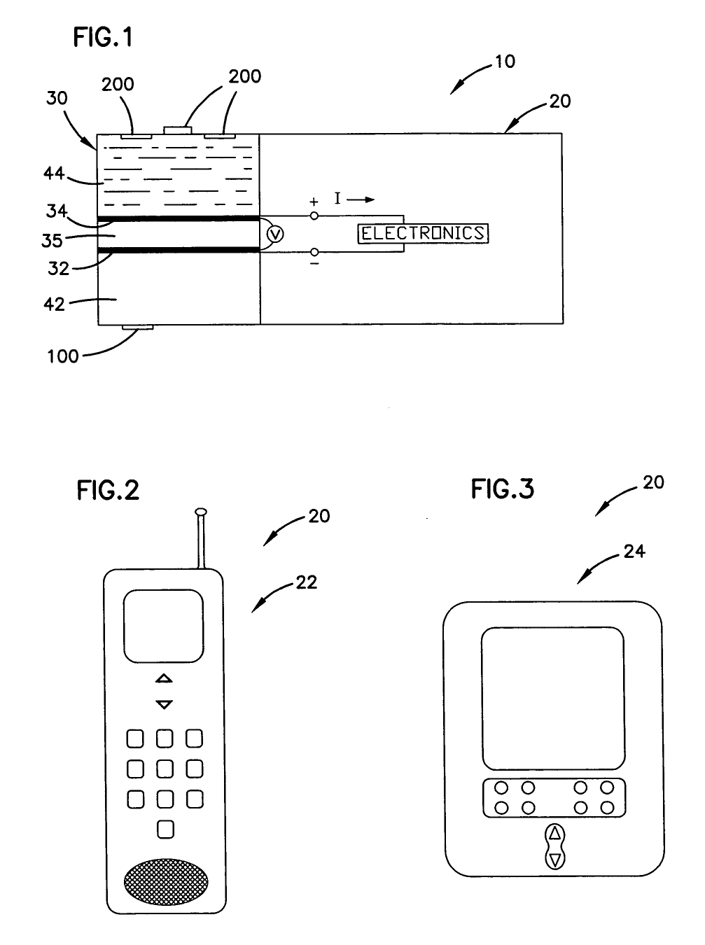

In a preferred embodiment of the invention, various filter elements for use on either the cathode side or the anode side of a portable fuel cell, such as a direct methanol fuel cell, are provided. Referring to the figures, wherein like elements are designated with the same reference numeral throughout the figures, a system incorporating various filter elements is shown. Particularly, FIG. 1 illustrates a system 10 that includes equipment 20 and a small or portable fuel cell 30. As used in this disclosure, a “portable” fuel is one that can be readily carried by an average person, and has a size no greater than about 6000 cm³ and a weight no greater than about 10 kg, preferably, no greater than about 1000 cm³ and a weight no greater than about 2 kg. As used in this disclosure, a “small” fuel cell is one that has a power rating of no more than about 1000 Watts, preferably no greater than 500 Watts.

Equipment 20 is powered by the electricity created by fuel cell 30 via a catalytic reaction at cathode 32 and anode 34. Examples of equipment suitable for operation by small or portable fuel cell 30 include cellular telephones, personal computing devices (PDAs), lap top computers, pagers, radios, and other electronic equipment that has traditionally been powered by batteries. Specific types of equipment 20 suitable for operation by fuel cell 30 are illustrated in FIGS. 2 and 3. FIG. 2 shows equipment 20, specifically cellular phone 22, and FIG. 3 shows equipment 20, specifically a hand-held personal computing device (PDA) 24.

There are five main known types of fuel cells, and fuel cell 30 may be selected from any of these. Proton exchange membrane fuel cells (PEMFCs) contain a solid polymer electrolyte. Their low temperature operation, high power density with the ability to vary their output quickly to meet shifts in power demand make their use ideal for both mobile and stationary applications, such as powering vehicles or buildings. PEM fuel cells use hydrogen as a fuel. A direct methanol fuel cell is a certain type of PEM fuel cell, using the hydrogen present in methanol as the fuel source. Alkaline fuel cells (AFCs) contain a liquid alkaline electrolyte and have been used primarily in space mission applications. Phosphoric acid fuel cells (PAFCs) utilize a phosphoric acid electrolyte and are currently used for commercial power generation. Molten carbonate fuel cells (MCFCs) contain a carbonate salt electrolyte, which becomes molten at the operating temperature of about 650° C. Solid oxide fuel cells (SOFCs) use a ceramic electrolyte material and operate up to about 1000° C. Both the MCFCs and the SOFCs can use carbon monoxide as fuel. However, although any of these five types of fuel cells would be suitable for use with the filter assemblies of the present disclosure, the preferred fuel cell is a PEM fuel cell, which is versatile and readily available as a small or portable fuel cell.

In a preferred embodiment, fuel cell 30 uses hydrogen as the anode fuel. The hydrogen fuel may be provided to anode 34 directly as hydrogen (e.g., hydrogen gas) or as an alternate source (e.g., methanol). Any hydrogen fuel cell, whether using hydrogen as a fuel or methanol, will benefit from a filter assembly according to the present disclosure positioned on the cathode side. A direct methanol fuel cell, also referred to as a liquid methanol fuel cell, will particularly benefit from a filter assembly according to the present disclosure positioned on the cathode side and a filter assembly according to the present disclosure positioned on the anode side.

A direct methanol fuel cell is illustrated in FIG. 1. Depending on the specific fuel cell used for the system, the methanol source may not be pure methanol, rather, the fuel may be a solution of methanol in water, usually about 20-50% methanol, although more dilute and more concentrated solutions are known and can be used.

Methanol 44, which provides hydrogen fuel, is supplied to anode 34 of fuel cell 30, typically as a liquid. Ambient air, or another oxygen or oxidant source 42, is supplied to cathode 32 of fuel cell 30. The oxygen may diffuse naturally to cathode 32, may be pumped (for example with a compressor or a pump), or may be provided by bottled source, for example. The hydrogen (from the methanol) and oxygen contact anode 34 and cathode 32 electrodes, respectively, in a manner that generates a voltage between the electrodes, creating electricity and heat, and producing water as the primary by-product. Fuel utilization levels of 75% are common, with a cathode gas flow volume of three times the stoichiometric level. That is, at a fuel utilization level of 75%, a fuel loss of 25% is experienced, for example, due to fuel crossing to the cathode. Although, fuel utilization levels of 90% have been demonstrated in controlled conditions; such a fuel utilization level has been demonstrated with two times the stoichiometric cathode gas level. It is anticipated that levels greater than 90%, and stoichiometric levels less than two times, will be attained.

Fuel cell 30 uses a catalyst to cause the hydrogen atom to split into a proton and an electron, each of which takes a different path to the cathode. The protons pass through an electrolyte 35 positioned in electrical contact with each of cathode 32 and anode 34. The electrons create a useful electric current (I) that can be used as an energy source for the electronics of equipment 20, before returning to the anode where they are reunited with the hydrogen protons and the oxygen to form water.

As seen in FIG. 1, a first filter assembly 100 is present at fuel cell 30, specifically, on the cathode 32 side, and a second filter assembly 200 is present on the anode 34 side.

Filter Assembly on Cathode Side

Referring now to FIGS. 5-8, various embodiments of first filter assembly 100 are illustrated. First filter assembly 100, positioned on the oxidant side of fuel cell 30, forms a selectively permeable barrier between the environment, typically ambient air, and fuel cell cathode 32. First filter assembly 100 manages the exposure of cathode 32 to particulate and gaseous materials, by selectively allowing the passage of certain gaseous molecules, such as oxygen, to cathode 32, and inhibiting particulate to reach cathode 32. As described in co-pending U.S. patent application Ser. Nos. 09/832,715, 09/879,441, 09/122,647, and 10/241,117 and in issued U.S. Pat. Nos. 6,432,177 and 6,638,339 (Dallas et al.) (the entire disclosures of all being incorporated herein by reference), fuel cell cathodes are susceptible to deterioration caused by particulate and chemical contaminants in the incoming air or oxygen stream. First filter assembly 100 also manages the movement of water away from cathode 32.

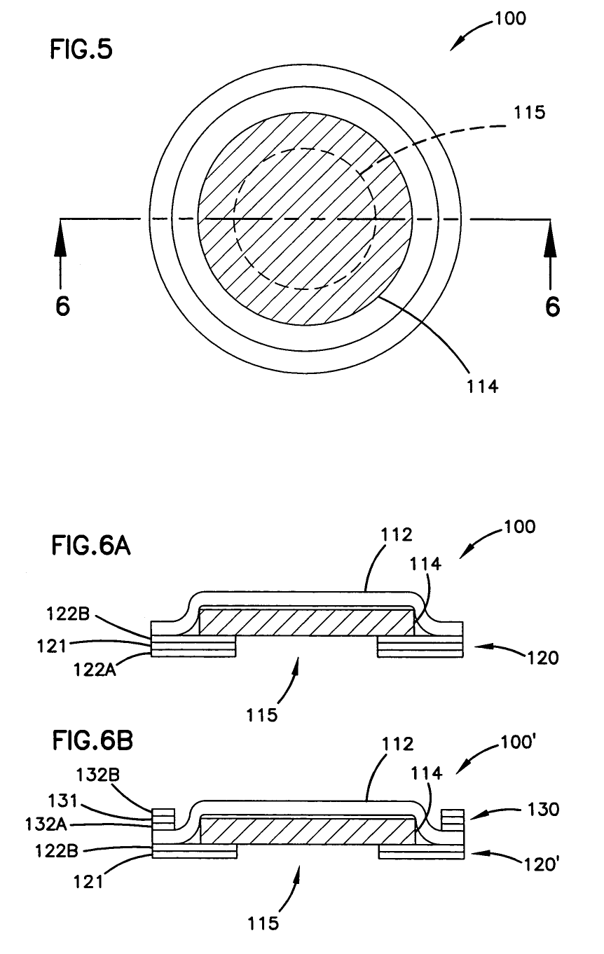

A first embodiment of a first filter assembly 100 is illustrated in FIGS. 5 and 6A. Assembly 100 includes a membrane 112 encasing an adsorbent material 114, both of which allow air flow therethrough. On the opposite side of membrane 112 is an adhesive construction 120 (FIG. 6A). Adhesive construction 120 provides an attachment mechanism for securing filter assembly 100 to an appropriate position on fuel cell 30. In the embodiment illustrated, adhesive construction is a multi-layer construction, having adhesive layers 122A, 122B sandwiching carrier 121. A suitable carrier 121 is PET, which provides rigidity to filter assembly 100. As seen in FIG. 6A, filter assembly 100 includes a port 115 defined by adhesive construction 120 to allow access to adsorbent material 114, as construction 120 inhibits flow of air or other gases therethrough. The size of port 115 can be adjusted to affect and optimize the overall rate of diffusion of oxygen to cathode 32 and water away from cathode 32. A membrane material (similar to or different than membrane 112) could be positioned between adhesive construction 120 and adsorbent material 114, such a membrane may be laminated or otherwise attached to adsorbent 114. This material may increase filtration, add hydrophobicity, and/or modify the plenum formed by port 115.

An alternate construction of the first embodiment of filter assembly 100 is illustrated in FIG. 6B as filter assembly 100′. Assembly 100′ includes membrane 112 encasing adsorbent material 114; on the opposite side of membrane 112 is an adhesive construction 120′. An additional membrane material (not illustrated) may be positioned between adhesive construction 120′ and extend across adsorbent material 114. Adhesive construction 120′ is a multi-layer construction for providing rigidity to filter assembly 100′, but does not provided a mechanism for securing filter assembly 100′ to fuel cell 30. Construction 120′ has one adhesive layer 122B adhering carrier 121 to membrane 112 and adsorbent 114. Filter assembly 100′ includes a second adhesive construction 130 that provides an attachment mechanism for securing filter assembly 100′ to an appropriate position on fuel cell 30. In the embodiment illustrated, adhesive construction 130 is a multi-layer construction, having adhesive layers 132A, 132B sandwiching carrier 131. Similar to filter assembly 100 of FIG. 6A, filter assembly 100′ of FIG. 6B includes a port 115 defined by adhesive construction 120′ to allow access to adsorbent material 114, as construction 120′ inhibits flow of air or other gases therethrough.

For both assemblies 100, 100′, membrane 112 allows passage of gaseous molecules therethrough and generally does not allow passage of liquids and particulate material therethrough. Examples of suitable materials for membrane 112 include, but are not limited to, fibrous woven materials or non-woven materials, paper or cellulosic material, or glass materials. Membrane 112 may be a hydrophobic, hydrophilic, or oleophobic material, although it is not necessary that membrane 112 have any of these characteristics. A material may be treated, such as with a post treatment, to provide the desired hydrophobic, hydrophilic, or oleophobic characteristic. A preferred membrane 112, however, is hydrophobic, such as expanded polytetrafluoroethylene (PTFE). Other suitable materials for membrane 112 include polyvinylidene fluoride (PVDF) and polypropylene (PP). Examples of specific, suitable expanded PTFE membranes include: “MD5834”, 87 micrometers thick with 0.1 micrometer pores; “EN 0701417”, 87 micrometers thick with 0.7 micrometer pores; “EN 0701552”, 87 micrometers thick with 1 micrometer pores; “EN 0701405”, 200 micrometers thick with 0.35-0.4 micrometer pores; and “EN 0701341”, 250 micrometers thick with 0.35 micrometer pores, all of which are available from Donaldson Company, Inc. An example of a specific, suitable polypropylene membrane is “EN 0701516”, 87 micrometers thick with 0.1 micrometer pores.

Also for both assemblies 100, 100′, sorbent material 114 adsorbs carbon-based and various other gaseous molecules or materials, such as VOCs, ammonia and SO₂, that may pass through membrane 112. Sorbent material 114 may permanently retain the desired contaminants or may release the contaminants over time.

Examples of suitable sorbent materials 114 include activated carbon, activated alumina, molecular sieves, ion exchange resins or other functional resins and polymers, diatomaceous earths, silica gel, or clays. The sorbent material may include a coating, additive, impregnant, or other treatment for selective adsorption or reaction. Impregnants include inorganic materials which can be impregnated using either an aqueous or organic solution.

More than one sorbent material 114 may be used in the filter assembly. For example, an activated carbon material may be used to adsorb hydrocarbons, acid gases (such as SO₂) and base gases (such as ammonia), and silica gel or other dessicant material may be used to inhibit passage of water, which is a by-product of the catalytic reaction, from cathode 32 to the outside of system 10. This water adsorbent element may adsorb, absorb, or otherwise inhibit water from leaving (such as by dripping, leaking, etc.) out from system 10. An example of a suitable material for a water adsorbent element is silica gel. In some embodiments, rather than adsorption of water, it may be desired to maintain the relative humidity at cathode 32 at a specified level by managed release of water from fuel cell 30. A desired level of relative humidity at cathode 32 is usually at least 50%, often 60-100%. In some constructions, carbon material may provide sufficient water management properties that no dessicant or other material specifically for water management is needed.

Various methods can be used to provide sorbent material 114. In one method, sorbent material 114 can be placed in a discrete pattern on a base material, such as on membrane 112. Sorbent material 114 can be an adsorptive slurry which is deposited with a screen printing type process; such a process for depositing a sorbent material is taught, for example, in U.S. Pat. No. 5,869,009 (Bellefeuille et al.), which is incorporated herein by reference. In another method, sheets of adsorbent or absorbent material can be converted (e.g., die cut) to form discrete pieces of sorbent material 114. These discrete pieces are then transferred or otherwise applied to membrane 112 or other porous carrier material. Other methods for producing sorbent material 114, and filter assembly 100, 100′ are suitable.

First filter assembly 100, 100′ of FIGS. 5, 6A and 6B has a narrow profile; that is, membrane 112 and adsorbent material 114, and any other layers, do not occupy much thickness. Typically such a construction as illustrated in FIGS. 5, 6A and 6B has a thickness of about 0.25 to 3 mm, usually about 0.75 mm. Additionally, filter assembly 100, 100′ has a generally soft, conformable structure defined by membrane 112 and adsorbent 114, and adhesive construction 120, 120′ provides some rigidity to the construction.

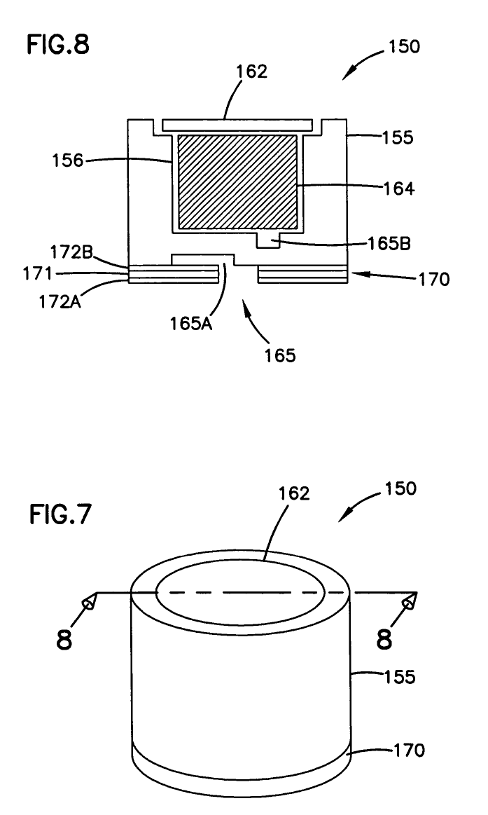

A second embodiment of first filter assembly 100 is illustrated in FIGS. 7 and 8 as filter assembly 150. First filter assembly 150 forms a selectively permeable barrier between the environment and fuel cell cathode 32, allowing the passage of gases (such as oxygen) therethrough and not allowing the passage of VOCs, acid gases, base gases, and particulate contaminants therethrough. First filter assembly 150 also manages the movement of water away from cathode 32.

Filter assembly 150 has an exterior housing 155, which provides a hard, overall physical structure of assembly 150. Typically housing 155 is plastic. Retained within housing 150 is a membrane 162 and an adsorbent mass 164. Membrane 162 is positioned generally on top of housing 155, but may be recessed to provide protection to membrane 162. Adsorbent 164 is retained within a pocket 156 in housing 155. Assembly 150 includes an adhesive construction 170 for securing assembly 150 to an appropriate position on fuel cell 30. In the embodiment illustrated, adhesive construction is a multi-layer construction, having adhesive layers 172A, 172B sandwiching carrier 171. A suitable carrier 171 is PET. Additionally, construction 170 inhibits flow of air or other gases therethrough.

Housing 155, together with adhesive construction 170, defines an air channel 165 extending from the exterior of filter assembly 150 to adsorbent 164. Channel 165 is a tortuous channel molded within housing 155 with a portion of a channel wall defined by adhesive construction 170. An aperture in adhesive construction 170 defines a first end 165A of channel 165. Second end 165B of channel 165 is positioned in close proximity to adsorbent 164.

Similar to filter assembly 100, discussed above, filter assembly 150 is positioned on a port or vent that provides a passage between cathode 32 and the outside atmosphere. Preferably, all air or other oxidant source passes through this port or vent in order to reach cathode 32.

Filter assembly 150 allows passage of desirable gaseous molecules such as air or other oxygen source both toward the cathode, but inhibits passage of particulate and gaseous chemical contaminants that might affect fuel cell performance.

Membrane 162 allows passage of gaseous molecules therethrough but inhibits passage of particulate contaminants. Examples of suitable materials for membrane 162 include, but are not limited to, fibrous woven materials or non-woven materials, paper or cellulosic material, or glass materials. Membrane 162 may be a hydrophobic, hydrophilic, or oleophobic material, although it is not necessary that membrane 162 have any of these characteristics. A preferred membrane 162, however, is hydrophobic, such as expanded polytetrafluoroethylene (PTFE). Other suitable materials for membrane 162 include polyvinylidene fluoride (PVDF) and polypropylene (PP).

Filter assembly 150 may include additional layers of material, such as layers of polymeric open screen or woven material, or non-woven materials. It can be appreciated that the layers of first filter assembly 150 may be any type of woven or non-woven materials that are sufficiently tight to contain adsorbent 164 yet allow passage of gases (such as oxygen) therethrough. The layers can be a single or multiple ply, depending on the desired properties of the material.

Adsorbent 164 allows passage of gases such as oxygen and nitrogen, but adsorbs hydrocarbons (VOCs), acid gases (e.g., SO₂, H₂S, Cl₂, NOx) and base gases (e.g., ammonia). Adsorbent 164 may permanently retain the contaminants or may release the contaminants over time. Adsorbent 164 may also manage water or water vapor travel to and from cathode 32.

Examples of suitable material for adsorbent 164 include activated carbon, activated alumina, molecular sieves, ion exchange resins or other functional resins and polymers, diatomaceous earths, silica gels or clays. The adsorbent material may include a coating, additive, impregnant, or other treatment for selective adsorption or reaction. Impregnants include inorganic materials which can be impregnated using either an aqueous or organic solution. More than one material may be used in adsorbent 164.

Various methods can be used to provide adsorbent mass 164. In one method, a mass of adsorbent particles are molded to form a mass of material. The particles may be retained together by a polymeric binder or by other means. Various constructions of molded adsorbent materials, and methods of making, are disclosed in U.S. Pat. Nos. 6,146,446 (Tuma et al.), 6,168,651 (Tuma et al.) and 6,491,741 (Tuma et al.), all of which are incorporated herein by reference.

Channel 165 also allows the passage of gases therethrough, but provides a restriction on their diffusion; in such a way, channel 165 buffers the diffusion rate of gas, such as oxygen, to cathode 32. Similarly, channel 165 allows the passage of vaporized water therethrough, but provides a restriction on the diffusion; in such a way, channel 165 buffers the diffusion rate of water away from cathode 32, so that a desired relative humidity at cathode 32 is maintained. The overall size of channel 165 (length, cross-sectional area, geometry, etc.) can be adjusted to affect the overall rate of diffusion of oxygen to cathode 32 and water away from cathode 32. U.S. Pat. Nos. 4,863,499 (Osendorf), 5,997,614 (Tuma et al.) and 6,491,741 (Tuma et al.), the entire disclosures of which are incorporated herein, describe various forms of tortuous channels that are suitable for incorporating into filter assembly 150 or variations thereof.

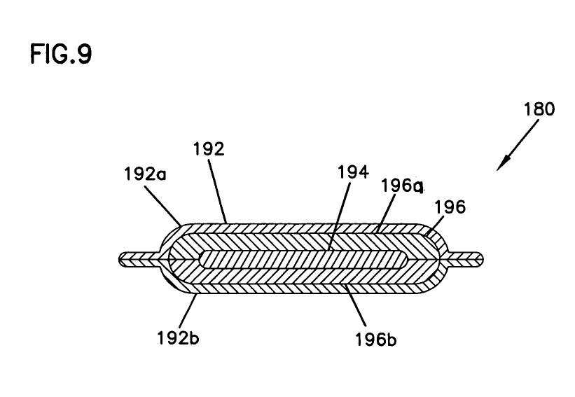

A third embodiment of a first filter assembly 100 is illustrated in FIG. 9 as filter assembly 180. Filter assembly 180 forms a selectively permeable barrier between the environment and fuel cell cathode 32, allowing the passage of gases therethrough and not allowing the passage of VOCs, acid gases, base gases, and particulates therethrough. Filter assembly 180 also manages the movement of water away from cathode 32.

Filter assembly 180 has an adsorbent element 194 encapsulated between two layers of electrostatic or membrane filtration media 196 and protective scrim 192. In particular, adsorbent element 194 is covered by filtration media 196a, 196b, which is then covered by protective scrim 192a, 192b.

Similar to filter assembly 100 and filter assembly 150, discussed above, filter assembly 180 is positioned on a port or vent that provides a passage between cathode 32 and the atmosphere outside of system 10. Preferably, all air or other oxidant passes through this port or vent in order to reach cathode 32.

Protective scrim 192 also allows passage of gaseous molecules therethrough but inhibits passage of particulate contaminants. The pressure drop through scrim 192 is generally minimal. Examples of suitable materials for protective scrim 192 include, but are not limited to, fibrous woven materials or non-woven materials, paper or cellulosic material, or glass materials. Protective scrim 192 may be a hydrophobic, hydrophilic, or oleophobic material, although it is not necessary that scrim 192 have any of these characteristics. A preferred protective scrim 192 is a woven polyester scrim, available from Donaldson Company under the designation “EN0701457”. Another suitable protective scrim 192 is a nonwoven polyester scrim, available from Donaldson under the designation “EN0701232”.

Electrostatic media or membrane 196 retains adsorbent 194 and allows passage of gaseous molecules therethrough but inhibits passage of particulate contaminants. Examples of suitable materials for media or membrane 196 include, but are not limited to, fibrous woven materials or non-woven materials, paper or cellulosic material, or glass materials. Multiple layers or materials may be laminated or otherwise provided to form layer 196. A preferred media or membrane 196 is an acrylic/polypropylene blend.

Adsorbent 194 is similar to adsorbent 114 and adsorbent 164, which allow passage of gases such as oxygen and nitrogen, but adsorbs hydrocarbons (VOCs), acid gases and base gases.

Filter assembly 180 is more suitable for fuel cell assemblies that utilize a driven or pressurized oxidant flow (e.g., pumped air), as such assemblies do not rely on diffusion to provide oxygen to the cathode. Additional details regarding filter assemblies similar to assembly 180 can be found, for example, in U.S. Pat. Nos. 5,997,618 and 6,077,335 (Isogawa et al.), both which are incorporated herein by reference.

In the embodiments of the first filter assembly 100 discussed above and illustrated in FIGS. 5, 6A, 6B, 7, 8 and 9, the filter assemblies have been a single unit. It is understood that the filter assembly may be composed of multiple units. For example, a first unit, providing gas diffusion therethrough but inhibiting particulate therethrough, may be positioned over a vent. A second unit, for example, having an adsorbent material, for adsorbing chemical contaminants and regulating humidity, may be positioned at a location remote from the vent. Examples of adsorbent portions, that can be positioned remote from an air inlet vent, include those disclosed in U.S. Pat. Nos. 5,876,487 (Dahlgren et al.), 6,143,058 (Dahlgren et al.) and 6,214,095 (Logan et al.), the entire disclosures of which are incorporated herein.

Filter Assembly on Anode Side

Referring again to FIG. 1, the anode side of fuel cell 30 includes second filter assembly 200. Second filter assembly 200 is constructed and arranged to allow passage of gaseous molecules therethrough, such as oxygen, nitrogen, carbon dioxide, etc., but to not allow liquid, such as methanol, to pass therethrough. Second filter assembly 200, in general, does not allow passage of fuel, water, etc. from fuel cell 30, but allows passage of atmospheric materials and fuel cell reaction by-products.

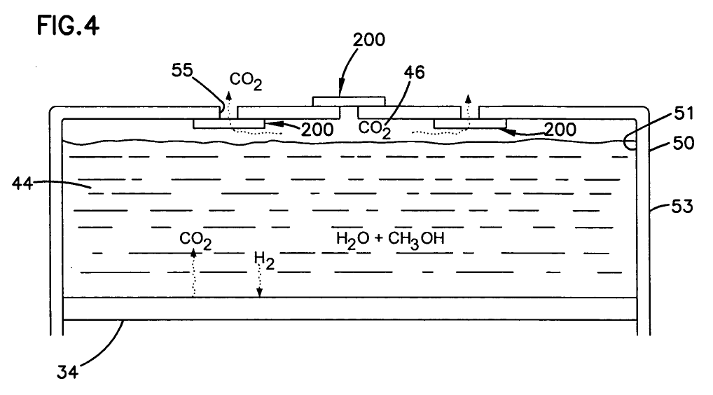

FIG. 4 illustrates an enlarged view of a portion of the fuel cell, in particular, a methanol source 50, in a vessel, is illustrated, with second filter assembly 200. Vessel 50 retains liquid methanol and is configured to abut anode 34; optionally, anode 34 may form a wall that defines the interior volume of vessel 50. Vessel 50, having an interior surface 51 and an exterior surface 53, retains a volume of liquid methanol 44 and gaseous carbon dioxide 46, and other gaseous material, therein. Carbon dioxide 46 is a by-product of the reaction at anode 34. Vessel 50 has at least one aperture 55 therein, the aperture providing a vent between the internal volume of vessel 50 and the outside of system 10. In the particular embodiment illustrate in FIG. 4, vessel 50 includes three apertures 55. Due to the usage of methanol from vessel 50, vessel 50 may include a port for addition of methanol, or, vessel 50 may be removable and replaceable from its relationship with cathode 34, thus allowing a spent vessel 50 to be replaced with a new or full vessel 50.

Second filter assembly 200, provided across aperture 55 of vessel 50, provides a selectively permeable barrier between methanol 44 and the outside of system 10. Second filter assembly 200 preferably allows the passages of gaseous molecules, such as oxygen, nitrogen, argon, and carbon dioxide. By-products of the reaction at anode 34, such as formic acid and formaldehyde, also permeate through first filter assembly 100. Second filter assembly 200 may be positioned on and secured to either interior surface 51 or to exterior surface 53 of vessel 50.

A preferred configuration for second filter assembly 200 is a membrane filter, also commonly referred to as a label filter, made from a hydrophobic and/or oleophobic material. A hydrophobic and/or oleophobic material allows passage of gaseous molecules therethrough but does not allow passage of liquids, such as liquid methanol, therethrough. Examples of suitable materials include expanded polytetrafluoroethylene (PTFE), polypropylene, and polyvinylidene fluoride (PVDF), these materials having tortuous pores or passages therethrough. The materials may include a post treatment or other coating that increases the hydrophobic and/or oleophobic characteristics.

PTFE is commercially available from Donaldson Company, Inc. under the brand name “Tetratex”, and from W.L. Gore & Assoc. under the brand name “Gore Tex”. PTFE is available in multiple thicknesses with various pore sizes. A preferred thickness for the hydrophobic and/or oleophobic material for second filter assembly 200 is about 12-260 micrometers. For a material with such a thickness, 0.1-2 micrometers pores are suitable, and pores as small as 0.05 micrometer, and even 0.01 may be suitable.

Examples of specific, suitable expanded PTFE membranes include: “MD 5834”, 87 micrometers thick with 0.1 micrometer pores; “MD 5897”, 87 micrometers thick with 0.2 micrometer pores; “EN 0701417”, 87 micrometers thick with 0.7 micrometer pores; “EN 0701552”, 87 micrometers thick with 1 micrometer pores; “EN 0701405”, 200 micrometers thick with 0.35-0.4 micrometer pores; and “EN 0701341”, 250 micrometers thick with 0.35 micrometer pores, all of which are available from Donaldson Company, Inc. An example of a specific, suitable polypropylene membrane is “EN 0701516”, 87 micrometers thick with 0.1 micrometer pores. An example of a specific, suitable PVDF membrane is “MD 5915”, 87 micrometers thick with 1 micrometer pores. “MD 5915”, “EN 0701341” and “EN 0701516” are available with oleophobic treatments thereon, to increase its repellence of methanol.

Second filter assembly 200 is preferably sized to cover the entire aperture 55 in vessel 50 (see FIG. 4) and to extend a little beyond onto interior surface 51 or to exterior surface 53 to provide a solid seal. Preferably, second filter assembly 200 extends about 1 to 10 mm past aperture 55.

An adhesive generally secures second filter assembly 200 to vessel 50, either to interior surface 51 or to exterior surface 53. If constructed to be applied to interior surface 51, and thus in contact with liquid methanol, the adhesive should be resistant to methanol and not deteriorate, solubilize, or dissolve over the intended working life of second filter assembly 200. A release liner or other peelable layer may be present on the adhesive prior to positioning second filter assembly 200, the release liner being removed before affixing the filter to the appropriate position on vessel 50. Other mechanisms to secure second filter assembly 200 to vessel 50 could also be used; for example, filter assembly 200 could be secured by thermal bonding (e.g., ultrasonic bonding or heat) or by mechanical means.

Second filter assembly 200 may include an absorbent or adsorbent material. Such sorbent material may be included to adsorb materials, rather than having them pass through filter assembly 200 into the atmosphere. For example, formic acid and formadehyde, by-products of the reaction at anode 34, would be adsorbed by sorbent material. Any sorbent material may permanently retain the desired contaminants or may release the contaminants over time. The sorbent material may include a coating, additive, impregnant, or other treatment that reacts with the contaminants, thus neutralizing them. Examples of suitable sorbent materials include activated carbon, activated alumina, molecular sieves, ion exchange resins or other functional resins and polymers, diatomaceous earths, silica or clays. Any sorbent material is preferably encased or otherwise surrounded by material, such as the hydrophobic material, to contain the sorbent material.

Although filter assemblies 100, 100′, 150 have been illustrated as being circular or cylindrical, it is understood that the first filter assemblies and second filter assemblies, or any portion thereof, can be any suitable geometric or contoured shape, such as oval, rectangular, octagonal, star-shaped, and the like.

Additionally, although filter assemblies 100, 100′, 150 has been illustrated as having a single vent or port 115, 165, it is understood that any first filter assembly or second filter assembly can have multiple vents or ports.

Various specific examples of filter assemblies are provided below.

Exemplary Filter Assemblies

### Example 1

A specific example of a suitable first filter assembly 100, similar to the embodiment illustrated in FIGS. 5 and 6A, is provided. Activated carbon material 114, prelaminated with PTFE and polyethylene and impregnated with a basic material, was die cut to circle having a diameter of 8.5 mm from a sheet of material. The adsorbent dot 114 was covered with a layer of expanded PTFE 112, having a thickness of about 200 micrometers and having a pore size of about 0.35 micrometer. Such a PTFE material is available from Donaldson Company, Inc., under the designation EN0701405. The layered construction was die cut to an 11.9 mm diameter circle. A pressure sensitive adhesive was applied to the side opposite the PTFE to provide an annular adhesive area having an inner diameter of 6.4 mm. The overall thickness of the filter assembly was about 0.75 mm. A silicon-free release liner was provided on the PSA. The steps described herein may be done in alternate orders.

Such a filter assembly 100 is commercially available from Donaldson Company, Inc. under the designation “Adsorbent Breather Filter”, or “ABF”. “ABF” filters are available from Donaldson with diameters from 10 to 100 mm. Various geometry shapes are available.

### Example 2

Another specific example of a suitable first filter assembly 150, similar to the embodiment illustrated in FIGS. 7 and 8, is provided. Activated carbon was molded into a tablet to provide an adsorbent mass 164. The tablet was positioned into a five-sided square plastic housing 155 having a diffusion channel 165 molded in the side opposite the open side. A piece of PTFE membrane 162, having a thickness of about 25 micrometers and having a pore size of about 1.5 micrometers, was positioned over the tablet. A pressure sensitive adhesive was adhered to the side of the housing having the diffusion channel 165, leaving the end 165A of the channel uncovered. The steps described herein may be done in alternate orders.

Such a filter assembly 150 is commercially available from Donaldson Company, Inc. under the designation “Adsorbent Breather Assembly”, or “ABA”. “ABA” filters are available from Donaldson with dimensions of 4 to 50 mm (width, length and height). Cylindrical “ABA” filters are also available, with dimensions of 4 to 50 mm (diameter) and 4 to 15 mm (height). Various geometry shapes are available.

### Example 3

Another specific example of a suitable first filter assembly 180, similar to the embodiment illustrated in FIG. 9, is provided. Beaded activated carbon was die cut to provide an adsorbent mass 194. The mass 194 was covered with an acrylic/polypropylene multilayer electrostatic filtration media 196 on each side of the adsorbent mass. A layer of woven polyester scrim 192, having a thickness of about 127 micrometers was positioned over each filtration media layer. The edges of the filtration media layers and scrim were sealed by ultrasonic welding to form a peripheral seal around adsorbent mass 194.

Such a filter assembly 180 is commercially available from Donaldson Company, Inc. under the designation “Adsorbent Recirculation filter”, or “ARF”. “ARF” filters are available from Donaldson with dimensions of 4 to 100 mm (width and length) and about 2 to 20 mm overall thickness, with a outer periphery thickness at the seal of about 1 to 5 mm. Various geometry shapes are available.

### Example 4

A specific example of a suitable second filter assembly 200 is provided. An expanded PTFE membrane 112, having a thickness of about 200 micrometers and having a pore size of about 0.35 micrometer, was die cut to a circular shape having a 4.4 mm diameter. Such a PTFE material is available from Donaldson Company, Inc., under the designation EN0701405. A pressure sensitive adhesive was adhered to the perimeter of the circle to provide an annular adhesive area having an inner diameter of 1.5 mm. The overall thickness of the filter assembly was about 0.75 mm. The steps described herein may be done in alternate orders.

Such a filter assembly 200 is commercially available from Donaldson Company, Inc. under the designation “Standard Breather Filter”, or “SBF”. “SBF” filters are available from Donaldson with diameters from 4 to 100 mm. Various geometry shapes are available.

### Example 5

A specific example of a suitable second filter assembly 200 which includes an adsorbent material is an ABF filter, described above under Example 1.

The foregoing description and examples have provided broad and specific examples of filter assemblies for use with fuel cells. It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size and arrangement of parts and types of materials within the principles of the disclosure to the full extent indicated by the broad general meaning of the terms in which the appended claims are expressed.

What is claimed:

1. A fuel cell assembly comprising:
(a) a portable fuel cell having a cathode in fluid connection with an oxidant intake port and an anode;
(b) a filter assembly positioned in fluid connection with the oxidant intake port and the cathode, the filter assembly comprising:
(i) at least one of a particulate removal feature and a chemical adsorbent feature; and
(ii) a water buffer feature;
(c) the filter assembly constructed and configured in the fuel cell so that oxidant, entering via the intake port, passes through the filter assembly, and so that water vapor, from the cathode, is managed by the water buffer feature to achieve a desired humidity level.

2. The fuel cell assembly according to claim 1, wherein the filter assembly comprises both the particulate removal feature and the chemical adsorbent feature.

3. The fuel cell assembly according to claim 2, wherein the filter assembly comprises one portion having the particulate removal feature, the chemical adsorbent feature and the water buffer feature therein.

4. The fuel cell assembly according to claim 3, wherein the filter assembly comprises a housing, with the particulate removal feature, the chemical adsorbent feature and the water buffer feature retained in the housing.

5. The fuel cell assembly according to claim 4, wherein the housing defines at least a portion of a diffusion channel.

6. The fuel cell assembly according to claim 2, wherein the filter assembly comprises one portion having the particulate removal feature and a second portion having the chemical adsorbent feature and the water buffer feature therein.

7. The fuel cell assembly according to claim 1, wherein the particulate removal feature is a membrane.

8. The fuel cell assembly according to claim 7, wherein the membrane is PTFE.

9. The fuel cell assembly according to claim 7 wherein the membrane is PVDF.

10. The fuel cell assembly according to claim 1, wherein the chemical adsorbent feature comprises activated carbon.

11. The fuel cell according to claim 10, wherein the chemical adsorbent feature comprises impregnated activated carbon.

12. The fuel cell assembly according to claim 1, wherein the fuel cell is operably connected to electronic equipment to provide power to the electronic equipment.

13. The fuel cell assembly according to claim 12, wherein the electronic equipment is one of a cell phone, personal computing device, or a lap top computer.

14. The fuel cell assembly according to claim 1, wherein the portable fuel cell has a weight of no greater than 2 kg.

15. A fuel cell assembly comprising:
(a) a portable, direct methanol fuel cell comprising:
(i) a cathode;
(ii) an anode; and
(iii) a liquid methanol source in fluid contact with the anode, the methanol retained in a compartment having a vent, the vent providing fluid contact between an interior of the compartment and an exterior of the compartment; and
(b) a filter assembly positioned within the vent, the filter assembly configured for fluid connection between the interior of the compartment and the exterior of the compartment, the filter assembly comprising a selectively permeable hydrophobic and/or oleophobic feature.

16. The fuel cell assembly according to claim 15, wherein the selectively permeable hydrophobic and/or oleophobic feature is a membrane.

17. The fuel cell assembly according to claim 16, wherein the membrane is PTFE.

18. The fuel cell assembly according to claim 16, wherein the membrane is PVDF.

19. The fuel cell assembly according to clam 15, wherein the filter assembly further comprises an adsorbent feature.

20. The fuel cell assembly according to claim 15, wherein the portable fuel cell has a weight of no greater than 2 kg.
